(19) United States
(12) Patent Application Publication
(10) Pub. No.: US 2015/0288802 A1
(43) Pub. Date: Oct. 8, 2015

(54) System and Mehtod for Managing the Use of a Mobile Device

(71) Applicant: Nathan Medina, Universal, TX (US)

(72) Inventor: Nathan Medina, Universal, TX (US)

(21) Appl. No.: 14/246,892

(22) Filed: Apr. 7, 2014

(51) Int. Cl. H04M 1/725; H04W 8/08; H04W 4/14

(52) U.S. Cl. CPC H04M 1/72577; H04W 4/14; H04W 8/08

(57) ABSTRACT

A system and method, in the form of a system software application, that prevents the unsafe operation of a mobile device while the user is in an environment or situation where attention must be focused on the safe operation of a motor vehicle. The system application provides for users (drivers) and an administrator. The administrator sets up the users and the parameters that control the users' operation of their mobile devices. Functions are provided within the system application to prevent user deactivation or circumvention of the parameters set. Additional functions allow the administrator to provide exceptions to the parameter controls as needed on occasion. The system application is operable on existing mobile networks in conjunction with existing types of mobile devices and smart phones.

### BACKGROUND OF THE INVENTION

1. Field of the Invention

The present invention relates generally to systems and methods for controlling communications with and between mobile devices. The present invention relates more specifically to a system and method for limiting the use of a mobile device where the user is within an environment or situation where the distracting use of the mobile device could be unsafe.

2. Description of the Related Art

The problems associated with texting while driving are well known. Mobile devices, and smart phones in particular, are known to be a significant source of distraction to individuals whose attention should be directed to the safe operation of a motor vehicle. Some efforts have been made in the past to provide means for limiting the use of smart phones and other mobile devices while the user is in motion, such as while driving a vehicle. These previous efforts are often easy for the user to work around by the simple deactivation of certain smart phone functions or the deactivation of the software application attempting to monitor and control the distracting use of the mobile device. Those previous efforts that do show some success are generally reliant on complex (and costly) additional hardware sensors and systems to prevent the users from working around the system.

It would be desirable to have a system application that could prevent the use of a smartphone or other interactive mobile device while the user was in an environment or situation that required their undistracted attention. It would be desirable if the system application could function with only the hardware and sensors normally present in a cellular communication network with standard smart phones and network connections. It would be desirable if such a system was easy to set up and configure, easy to operate, and easy for an administrator to grant exceptions to various users of the system on an as needed basis.

In fulfillment of the above and further objectives, the present invention provides a system and method, in the form of a system software application, that prevents the unsafe operation of a mobile device while the user is in an environment or situation where their attention must be focused on the safe operation of a motor vehicle. The system application provides for users (drivers) and an administrator. The administrator sets up the users and the parameters that control the users' operation of their mobile devices. Functions are provided within the system application to prevent user deactivation or circumvention of the parameters set. Additional functions are included to allow the administrator to provide exceptions to the parameter controls as needed on occasion. The system application is operable on existing mobile networks in conjunction with existing types of mobile devices and smart phones.

### SUMMARY OF THE INVENTION

The present invention therefore provides a smartphone application that serves primarily to prevent texting while driving. The system application also prevents handheld phone usage, and any other smart phone distraction that may take a driver's attention off of the road while they are behind the wheel. There are two primary accounts that make up the system application; the administrator account and the driver account. The administrator account sets parameters that dictate driver phone operation. The parameters an administrator can control are, speed, time of day, and days of the week. For example, a driver phone may be set with the following parameters: 10 mph, 9:00 am-5:00 pm, Monday through Friday. This means that the driver phone will be restricted when the vehicle reaches the selected speed, between the selected hours on these selected days of the week.

Key system features include a Block Screen restriction that prevents drivers from using their smart phones in unsafe conditions. This screen appears on the phone when the parameters have been breached. The Block Screen will disappear when it is safe. There are two Block Screens a driver may encounter. There is the standard Block Screen and the Bluetooth® Block Screen. The standard Block Screen has two buttons within it; an Emergency button and a Disable button. The Emergency button, when pressed, will go to a Call Screen and will automatically populate with the emergency number (911 for example). This is the only call allowed while driving without a Bluetooth® connection. The Disable button, when pressed, will prompt the driver to enter the administrator's Unblock Password. If the driver's device has a Bluetooth® connection the Block Screen will have an extra button present marked Voice. Once pressed, the phone will prompt the driver to speak the name of person they wish to call.

Key system features further include an Unblock Password function that allows the administrator to give an Unblock Password to any of the drivers on an as needed basis. When entered on the Block Screen, this Unblock Password will disable the system application and allow for unrestricted phone use. The Unblock Password is maintained through the Administrator Screen within the system application or on the system website. The administrator may change this Unblock Password at any time.

Key system features further include limitations on the use of Text Messaging wherein a driver's smart phone cannot send text messages or read incoming texts while in motion. The driver may receive a text alert tone or vibration, however, the driver will not be able to read the text until the vehicle has come to a stop. System application features further include limitations on the use of Hand Held Phone Calls where, in situations in which the driver does not have a Bluetooth® connection they will not have the ability to make outgoing calls while driving. Incoming calls go straight to voicemail. Once the driver has stopped they may make a call. When the vehicle has started moving again and surpasses the speed parameter the call will automatically terminate. If the smart phone device has a Bluetooth® connection the driver will have the ability to make outgoing calls while driving by way of voice activated dialing. The driver may also receive incoming calls by way of an active Bluetooth® connection.

The driver will at no time be able to go into any other smart phone applications, email, Internet or any other normal functions while the vehicle has breached any of the parameters set by the administrator. Additional functions to deter drivers from trying to disable the system application include a unique On/Off Auto Block function. With this function, when a driver manually shuts off his or her smart phone or the phone loses power, the system application will automatically log in and run the Block Screen in the foreground when it is turned back on. In addition, if a driver does not login at the beginning of a day, the Default Parameters will automatically run. The system application Default Parameters are intended to be the most restrictive. The Default Parameters may, for example, activate at 10 mph, 12:00 am-12:00 pm, Monday through Sunday. Detailed logins are visible to the administrator within the system application and on the system website.

Further system application safeguards include a Manual Log Off Text Alert that activates when a driver manually logs off of the system application. Such an action prompts an immediate text message notification sent to the administrator. A Manual GPS Disable Text Alert activates when a driver manually turns off the GPS smart phone function. Such an action also prompts an immediate text message notification sent to the administrator. If a driver disables the Internet connection or loses its communication signal, the system application will still function normally as it only requires an Internet connection to log in and log out.

In addition to the above safeguards, the system application provides significant administrator control. If the administrator decides to give a driver the Unblock Password for any special circumstances they may do so. However, the administrator must be aware that the driver may continue to disable system application functions until the Unblock Password is changed. This can be done from the administrator's system application or from the system website. In addition, the administrator has the option to directly disable the system application functions at any time. This can be done for a specific driver or for many drivers. This is done by simply checking the box marked Disable System located on the administrator's system application or the system website. To re-enable system application controls, the administrator simply un-checks the box.

### BRIEF DESCRIPTION OF THE DRAWINGS

FIG. 1 is a schematic diagram representing the overall hardware and network environment associated with the operation of the system and method of the present invention.

FIG. 2 is a functional block diagram showing the various electronic databases and electronic data processing systems associated with operation of the system and method of the present invention.

FIGS. 3A-3D are flowchart diagrams disclosing the method steps and operational routines within the overall system and method of the present invention.

FIG. 4 is a flowchart representing the method steps associated with optional GPS geofencing functionality for the system and method of the present invention.

### DETAILED DESCRIPTION OF THE PREFERRED EMBODIMENTS

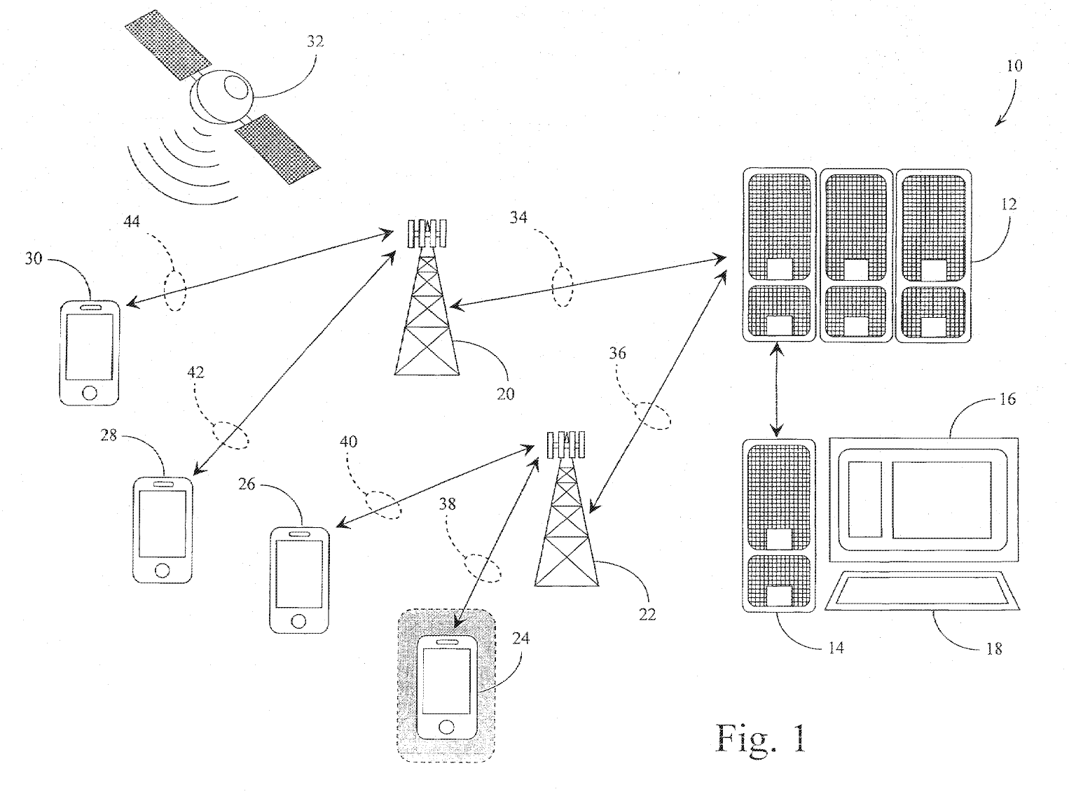

Reference is made first to FIG. 1 for an overview of the system architecture associated with the hardware components required for operation of the system and method of the present invention. Networked system 10 in the preferred embodiment includes a web-based server 12 that is connected to an administrator computer 14, having display 16 and user input keyboard 18. This connection between the web-based server 12 and the administrator computer 14 may be any of a number of different Internet connections whereby an administrator may log on to the web-based application software through means typical in the field. By way of the Internet, web-based server 12 is also connected to any of a number of smart phones and other wireless data processing devices that are capable of connecting to the Internet by way of wired connections, Wi-Fi connections, or mobile network connections as shown in FIG. 1.

Those skilled in the art will recognize that the example shown in FIG. 1 of a mobile Internet connection implemented from cell towers 20 and 22 by way of network connections 34 and 36 may be replaced by other types of Internet connections to the web-based server 12. Most commonly the system of the present invention will operate on mobile phone and more specifically smart phone components capable of connecting to the Internet through cellular or mobile network connections. The example of the system shown in FIG. 1 includes four mobile smart phones, one of which is represented as an administrator device. Smart phone 24 is connected to a mobile network system through wireless connection 38 and serves by way of installed application software, as an administrator for the system. Most if not all of the functions that the administrator can carry out on the desktop administrator computer 14 can be implemented on the mobile platform associated with administrator smart phone 24.

The remaining smart phones shown in FIG. 1, namely smart phones 26, 28 & 30 represent users of the system typically operating within a vehicle, either as driver or passenger. Each of these smart phones, 26, 28 & 30, are likewise connected to mobile Internet through the cellular network by way of wireless connections 40, 42 & 44. Each of the smart phones therefore interacts with the system by way of installed application software as well as web-based application software, and in some instances administrator software located on administrative computer 14.

The only additional hardware element required for operation of the system is GPS satellite system 32. While other components may exist within the various signal paths associated with the wireless Internet and cellular network systems, the only additional external signal required for operation of the system is the GPS satellite system that is already in place in association with GPS location services provided on most smart phones. Beyond the hardware components identified in FIG. 1, additional smart phones as well as additional administrator PCs and even user PCs may be utilized. Any device connectable to the Internet and capable of installing a modest component of the application software could be included in an expanding architectural structure for a given system installed for a given set of users.

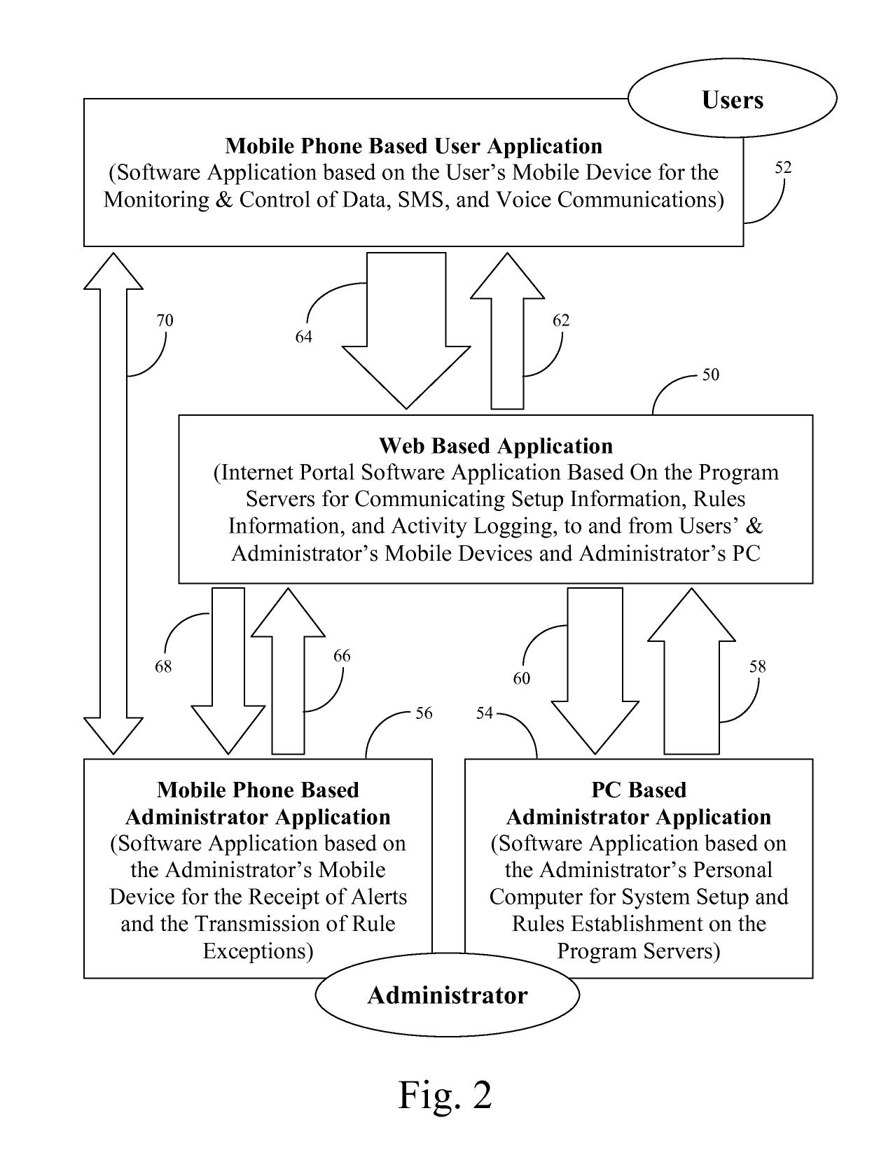

Reference is next made to FIG. 2 for a description of the various installed application software elements required to carry out the operation of the system and method of the present invention. As initially identified in FIG. 1, there are four basic components to the application software system operating the method of the present invention. These four components include mobile phone-based user application 52, the web-based application 50, the PC-based administrator application 54, and a mobile phone-based administrator application 56. In some embodiments of the present invention, mobile phone-based user application 52 may be identical to mobile phone-based administrator application 56, and will differ in functionality based only upon the password entered by the user with an administrator password opening up additional functionality not available to other users.

Web-based application 50 comprises an Internet portal software application based on the program servers for communicating setup information, rules information, and activity logging, to and from user's and administrator's mobile devices as well as the administrator's PC. Mobile phone-based user application 52 is a software application based on the user's mobile device for monitoring and control of data, SMS, and voice communications. Mobile phone-based administrator application 56 is likewise a software application based on the administrator's mobile device for the receipt of alerts and the transmission of rule exceptions as well as the monitoring of the overall system. At present each of the two mobile phone-based applications would preferably be established for both iOS® and Android® operating systems. The PC-based administrator application would likewise be based on one or more of the common PC or Mac operating systems such as Windows®, iOS®, Linux®, etc.

PC-based administrator application 54 comprises a software application based on the administrator's personal computer for initial system setup and rules establishment on the program servers. In this process of initial setup communication occurs between PC-based administrator application 54 and web-based application 50 through the Internet connections described above. This two-way communication includes uploading 58 of user information profiles and rules to the web-based application as well as downloading 60 of ongoing alerts, changes in user information, and location services information from web-based application 50.

Each user mobile phone communicates information to and from web-based application 50 as well. Established rules and other information from the administrator may be communicated by download 62 from web-based application 50. This may occur on a continuous basis or on a prompted basis. The user uploads 64 a quantity of information to web-based application 50 in the process of carrying out the monitoring functionality of the system. Much of this information is relayed to the administrator by download 60 as indicated. The administrator's mobile phone system likewise interacts with the web-based application 50 by uploading 56 changes and additions to user information, rules and so on. The administrator mobile phone likewise downloads information 68 from web-based application 50 in the form of alerts and other ongoing information and profile changes made by the users.

Finally, it is anticipated that some two-way communication 70 between the user mobile phones and the administrator mobile phone could be used to implement many functional steps in the system and method of the present invention. The ability to obtain permissions and exceptions to the rules directly from the administrator, who may be operating only with a mobile device, is important to the full functionality of the system. Likewise standard text messaging (SMS), mobile email communications, and of course voice communications may play a role, especially in the operation of exceptions to standard operating procedures.

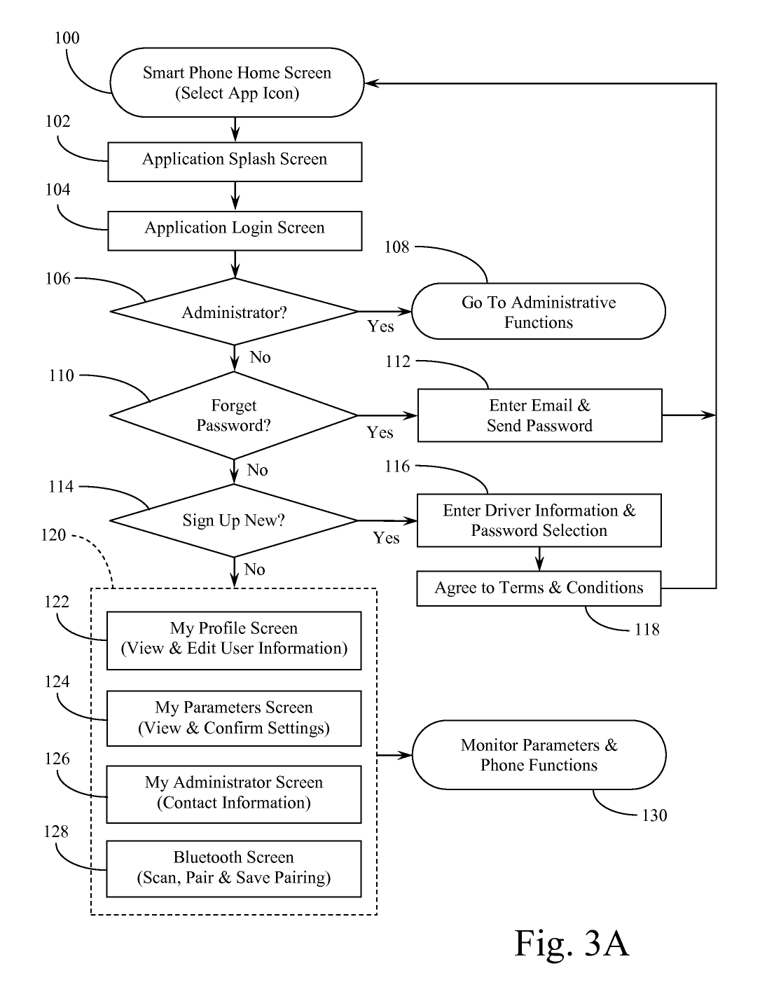

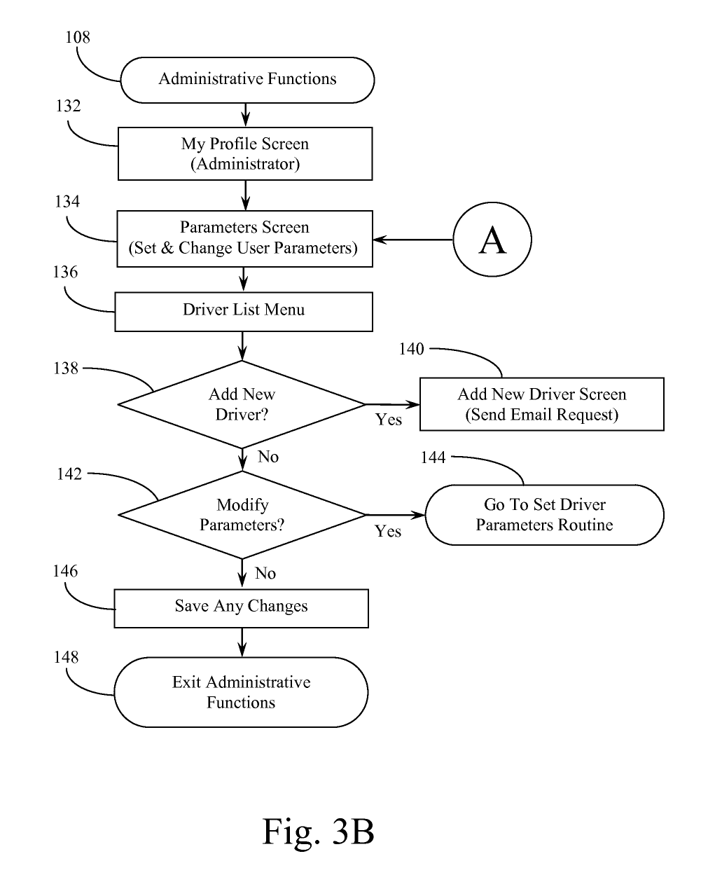

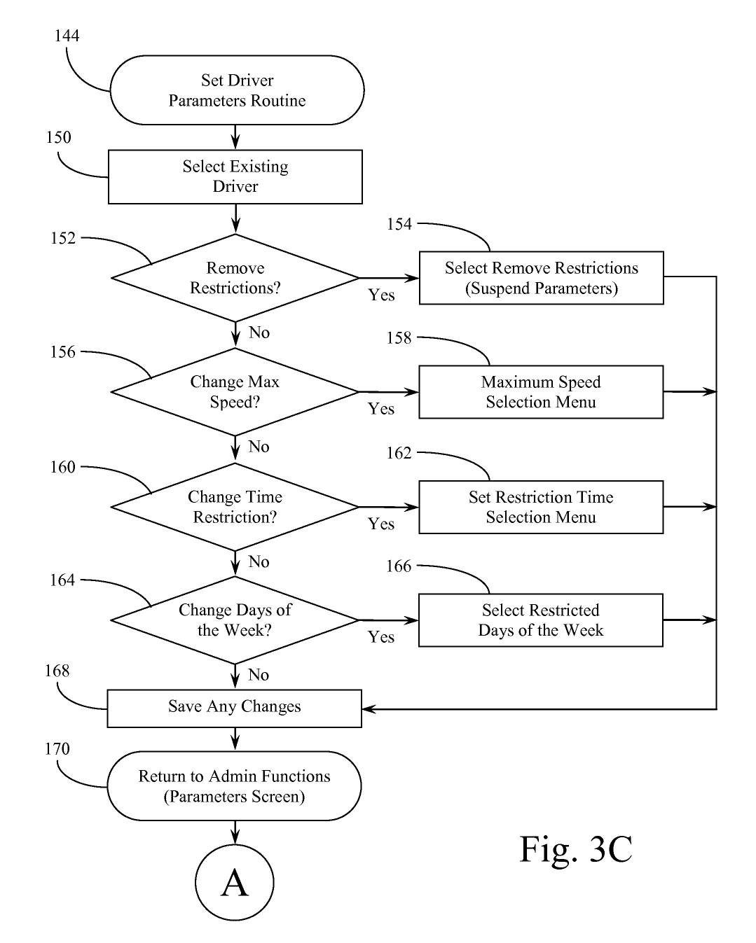

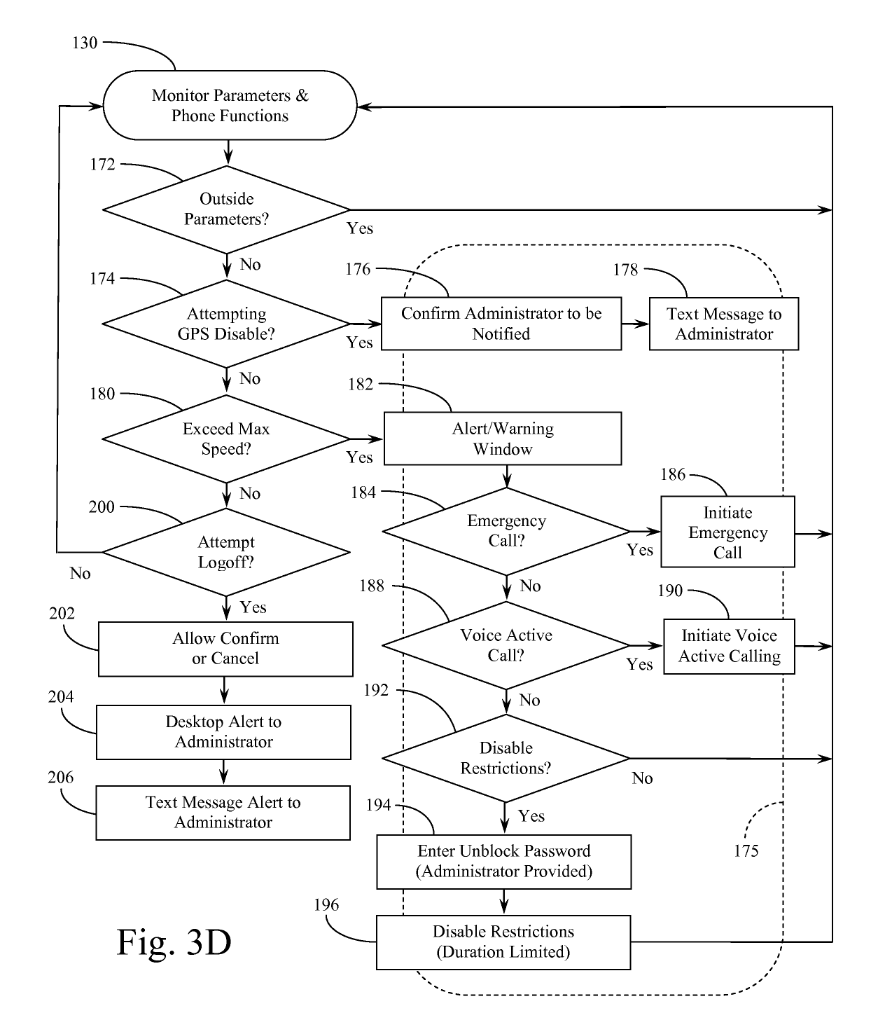

Reference is next made to FIGS. 3A-3D for a detailed description of the basic flow of the method of the present invention. All of the method steps in FIGS. 3A-3D are shown as they would be implemented on a mobile smart phone environment without reference to the web-based application or an administrator PC. Those skilled in the art will recognize however that many of the steps disclosed will be carried out with the communications link established through the web-based server, and in some instances the administrator's PC. For example, the administrator setup functionality which is shown in these flowchart figures as being carried out primarily on the administrator's mobile phone platform could all be implemented from an administrator PC in the same manner.

FIG. 3A represents the initial set of steps associated with activating the application on a mobile phone device. The method initiates at Step 100 with a smart phone home screen wherein the user selects the system application icon to begin the system application process. This prompts the application splash screen at Step 102 and initiates the application login screen at Step 104. Initially, the system determines at Step 106 whether the user is an administrator or not. If the user is an administrator the system goes to the administrative functions at Step 108. If the user is not an administrator the system prompts for entry of the user password. If the user does not have a password or enters the wrong password the system prompts at Step 110 to determine whether the user has forgotten the password. If so, the user is prompted to enter their email and the password is sent to the user at Step 112. The process then returns the user to the initiation of the application at Step 100.

If the user did not forget their password at Step 110 but rather does not have a password, then at Step 114 the system proceeds to allow the user to setup a new user account. This begins at Step 116 where the user enters driver information and selects a password. The user then agrees to the terms and conditions at Step 118, after which the system sets up the new user, and the user is directed back to the initial activation of the software application from the smart phone home screen at Step 100.

If the user is not an administrator, has not forgotten their password, and is not signing up for a new account, then the system recognizes the appropriate password and proceeds to the basic operational screens that are shown in FIG. 3A by dashed line encompassing Step 120. Included in these operational screens are the My Profile Screen at Step 122 wherein the user may view and edit user information, as well as the My Parameters Screen at Step 124 where the user may view and confirm the settings for their account. In addition, the My Administrator Screen at Step 126 provides contact information (phone and email address information) for that particular user's administrator. Finally, operational screens at Step 120 include Bluetooth® Screen at Step 128 which allows the user to scan and pair with Bluetooth® devices in association with the mobile phone device. This information may be saved such that automatic reconnection may occur between the same device Bluetooth® and the same mobile phone.

As the operational screens at Step 120 are presented to the user and prompt various input and information feeds, the overall monitoring of parameters and phone functions occurs at Step 130. These functions are described in more detail in FIG. 3D. FIG. 3B discloses the basic set of administrative functions called from Step 108 in FIG. 3A. Administrative functions initially include at Step 132 the My Profile Screen for the administrator. This is followed by the Parameter Screen for the administrator at Step 134 where the administrator is able to set and change user parameters. This generally includes Step 136 which provides a Driver List Menu. The administrator is asked initially at Step 138 whether a new driver is to be added. If so, then the system proceeds at Step 140 to the Add New Driver Screen wherein the administrator sends an email request to the user to input the appropriate account setup information. If the administrator is not adding a new driver then the system queries at Step 142 whether the administrator wishes to modify parameters. If so, the system proceeds to Step 144 to the Set Driver Parameters routine referenced in detail in FIG. 3C. If no further parameters are being modified, and/or if any new drivers have been added, the system saves any changes made by the administrator at Step 146 and exits the administrative functions at Step 148.

FIG. 3C represents the process of setting driver parameters carried out by the administrator. At Step 144 this Set Driver Parameters routine is initiated. The administrator selects an existing driver at Step 150 and the system presents a number of queries to the administrator regarding the various parameters to set and/or change. Query Step 152 determines whether the administrator wishes to remove restrictions entirely from any user. If so, the system proceeds at Step 154 to select Remove Restrictions which essentially removes the parameters until the administrator un-checks the selection box on their User Data Screen. After this occurs the system proceeds to save any changes at Step 168 and returns to the administrative functions, the Parameters Screen, at Step 170. If restrictions are not being removed but the maximum speed for a user is being changed then at query Step 156 the system is directed to the Maximum Speed selection menu at Step 158. Changes are made and again saved at Step 168 before returning to administrative functions at Step 170.

Additionally, the system queries whether time restrictions are being changed for a particular user at query Step 160. If so, the system proceeds at Step 162 to allow the administrator to set restriction time by providing a Restriction Time selection menu. Again, this information is saved and the system returns to the Administrative Function Parameters screen. Finally, at query Step 164 the system asks whether the administrator wishes to change any days of the week in the time and day restriction category for a particular user. If so, the system proceeds at Step 166 to allow the administrator to make and select the Restricted Days of the week for a particular user. Once again, the system saves any changes at Step 168, proceeds at Step 170 to return to the administrative functions Parameters Screen, through Connector A back to Step 134 shown in FIG. 3B.

FIG. 3D represents the operational status of the system once all user information and parameters have been set up. The monitor parameters and phone functions Step 130 constantly makes a number of queries of the user phone activity. These include determining whether the user is operating outside the day and time parameters established for that user at Step 172. At Step 174 the phone constantly determines whether the user is attempting to disable the GPS location services on the phone. At query Step 180 the system is constantly monitoring GPS to determine whether the user is exceeding the maximum speed limits established for that user. Finally, at query Step 200 the phone is constantly determining whether the user is attempting to log off of the system application or to otherwise disable the system application.

If the user is outside the day/time parameters determined at query Step 172, the system simply returns to the monitoring functionality at Step 130. Only if the user is within the day/time parameters do the additional parameters carry any weight and determine any actions. If the user is within the confines of the day/time parameters, and is attempting to disable the GPS location services determined at Step 174, the system confirms with the user at Step 176 that the administrator will be notified of this action. This is followed by a text message to the administrator at Step 178. Step 175 represents (in dashed outline) all of the actions that are encompassed within the Block Screen functionality of the system and method described.

If the user attempts to log off of the application as determined at query Step 200, the system allows the user to either confirm or cancel this action at Step 202 followed by, if the action is not canceled, an alert to the administrator desktop at Step 204 as well as a text message alert to the administrator at Step 206.

If the user exceeds the maximum speed as determined at query Step 180 the monitoring system proceeds to present a Block Screen with an alert warning window at Step 182. This presents the user with a number of legitimate options other than the prohibited text messaging or standard telephone dialing use of the mobile phone. The first of these exceptional actions is queried at Step 184 and asks whether the user wishes to make an emergency call, such as a 911 call. If so, the system allows and initiates the emergency call at Step 186.

If the user is not making an emergency call, the system queries as to whether a voice activation call is being made at query Step 188. If so, voice active calling is permitted and initiated at Step 190. Note that this process may generally require a previous Bluetooth® pairing as described above. Finally, at query Step 192 the system determines whether the user wishes to disable the restrictions associated with its ordinary use of the smart phone. If not, the system simply returns to the monitoring parameters and phone functions at Step 130. If the user does wish to disable the restrictions at query Step 192 the system proceeds at Step 194 to prompt for an unblock password provided by the administrator to the user. If the unblock password entered is correct the system proceeds at Step 196 to disable the restrictions on a duration limited basis. This disable restrictions status is active as long as the administrator permits the same to occur for a particular user.

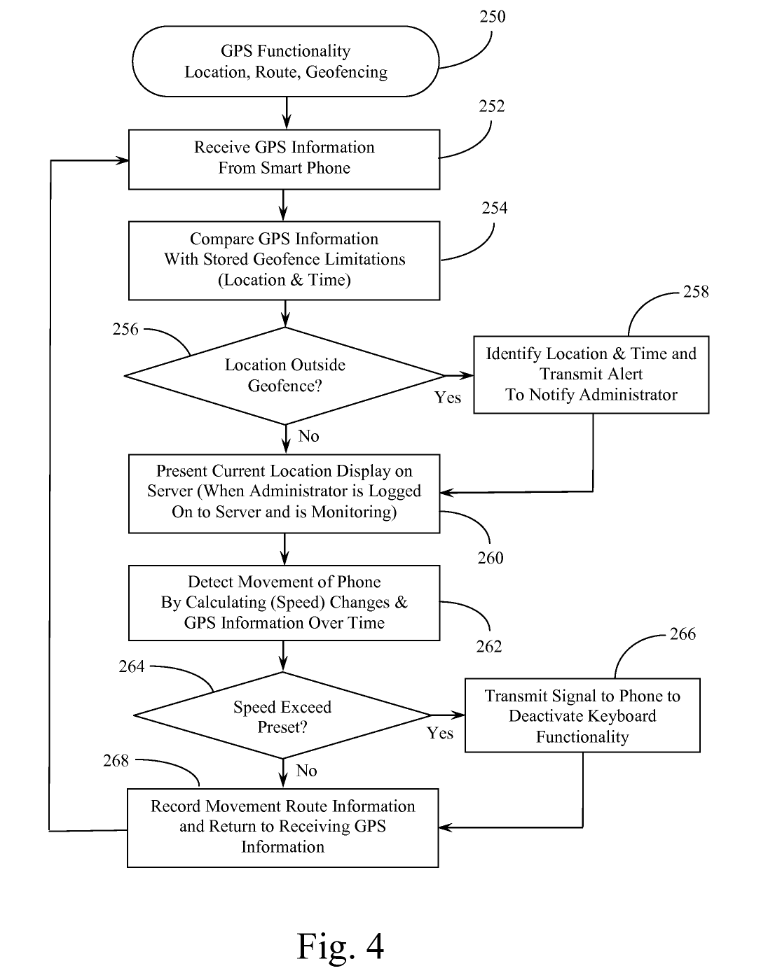

Reference is next made to FIG. 4 for a brief description of certain additional optional functionality associated with the GPS and location services operation of the smart phones of the users. Step 250 involves the initiation of GPS functionality including location, route and geofencing information. The first step in this process is to receive GPS information from the smart phones at Step 252. The system compares this GPS information with stored geofence limitations based on both location and time/day information at Step 254. The system then determines at query Step 256 whether the user is located outside the established geofence. If so, the system identifies the location and time of this user excursion outside the geofence and transmits an alert to notify the administrator at Step 258. Additionally, after transmitting the alert, the system proceeds at Step 260 to present current location display on the server which is available to the administrator when logged onto the server and is monitoring from the administrator PC or in some cases the administrator mobile phone. This current location display at Step 260 is also available to the administrator while the user is located within the established geofence.

In addition to simple location services associated with the user's smart phone, the system may detect the rate of movement of the phone by calculating speed changes and GPS information over time at Step 262. Based on this information the system determines at query Step 264 whether the user has exceeded a preset speed. If so, the system transmits a signal to the phone to deactivate keyboard functionality on the user phone at Step 266. Whether or not the preset speed is exceeded at Step 264 and a transmit signal to deactivate keyboard functionality is sent, the system continues to record movement route information and returns to the receiving of GPS information at Step 268.

Although the present invention has been described in conjunction with various hardware devices including mobile data processing devices, fixed PC devices, and Internet and other network connection systems, those skilled in the art will recognize that the functionality of the system and method of the present invention could be implemented in conjunction with a variety of different data processing systems and networks. The mobile devices described in the above detailed description of the preferred embodiments have generally been described as the standard smart phone devices although, again, those skilled in the art will recognize that mobile communication systems built into vehicles could also implement the functionality of the system and method of the present invention. In addition, although a web-based application has been identified in the preferred embodiment, those skilled in the art will recognize that the web-based system may be an invisible portal that involves no user or administrator activity other than what occurs through the mobile phone devices. In fact, initial implementation of the system and method of the present invention may preferably be made through simple communication between an administrator application installed on an administrator smart phone and user applications installed on user smart phones. Alternately, as described in the above detailed description, web-based application functionality may be provided to allow both users and certainly the administrator to interact with the system through other than mobile devices. This could be especially beneficial during setup routines for users and monitoring routines for administrators. In addition, although the above embodiments have been described primarily with reference to “drivers” as the “users” of the mobile devices, those skilled in the art will recognize other environments and situations where the system and method of the present invention would facilitate the safe behavior of an individual where that individual is not operating a motor vehicle. Such variations do not depart from the spirit and scope of the present invention as defined in the following claims.

I claim:

1. A system for controlling the use of a mobile communication device within a communications network, the system comprising:
at least one user mobile communication device, the mobile device having voice and short messaging service (SMS) capabilities, and further having an electronic data processor operating a system software application capable of controlling the functionality of the at least one mobile communication device; and
an administrator control device in wireless communication with the at least one user mobile communication device, the administrator control device having voice and short messaging service (SMS) capabilities, and further having an electronic data processor operating a system software application capable of setting parameters for controlling the functionality of the at least one user mobile communication device;
wherein the at least one user mobile communication device and the administrator control device are operable over a wireless communications network.

2. The system of claim 1 wherein the at least one user mobile communication device further comprises a GPS sensor for providing location and motion information to the system software application.
